(19) United States
(12) Patent Application Publication
(10) Pub. No.: US 2014/0166441 A1
(43) Pub. Date: Jun. 19, 2014

(54) TRANSFERRING DEVICE

(71) Applicant: HON HAI PRECISION INDUSTRY CO., LTD., New Taipei (TW)

(72) Inventor: TA-TUNG LIN, New Taipei (TW)

(73) Assignee: HON HAI PRECISION INDUSTRY CO., LTD., New Taipei (TW)

(21) Appl. No.: 14/065,496

(22) Filed: Oct. 29, 2013

(30) Foreign Application Priority Data
Dec. 14, 2012 (CN) 2012105418077

(51) Int. Cl. B65G 15/10

(52) U.S. Cl. CPC B65G 15/10
USPC 198/604

(57) ABSTRACT

A transferring device is used for transferring discs. The transferring device includes a frame, a first transferring member, a second transferring member, and a driving device. The disc is clamped by the first transferring member and the second transferring member, and the first transferring member and the second transferring member grip the edge of the disc rather than a data region of the disc. The driving device drives the first transferring member and the second transferring member to force the disc to transfer.

### BACKGROUND

1. Technical Field

The present disclosure relates to transferring devices, particularly to a transferring device for automatically transferring a disc.

2. Description of Related Art

When a digital video disc (DVD) player has been manufactured, the DVD player needs to play several discs to determine if the DVD player satisfies predetermined and expected standards. When the DVD player is tested, the discs are typically replaced by a manipulator. However, the manipulator always grips opposite surfaces of each disc, thus the discs is easily scratched.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a machine for loading and unloading materials.

FIG. 2 is the machine of FIG. 1 viewed from another aspect.

FIG. 3 is an exploded view of the machine of FIG. 1.

FIG. 4 is the machine in FIG. 3 viewed from another aspect.

FIG. 5 is an exploded view of a part of the machine of FIG. 3.

FIG. 6 is the machine of FIG. 5 viewed from another aspect.

FIG. 7 is an isometric view of a part of the machine of FIG. 3.

FIG. 8 is an exploded view of the machine of in FIG. 7.

FIG. 9 shows a part of the machine of FIG. 1 being in a first position.

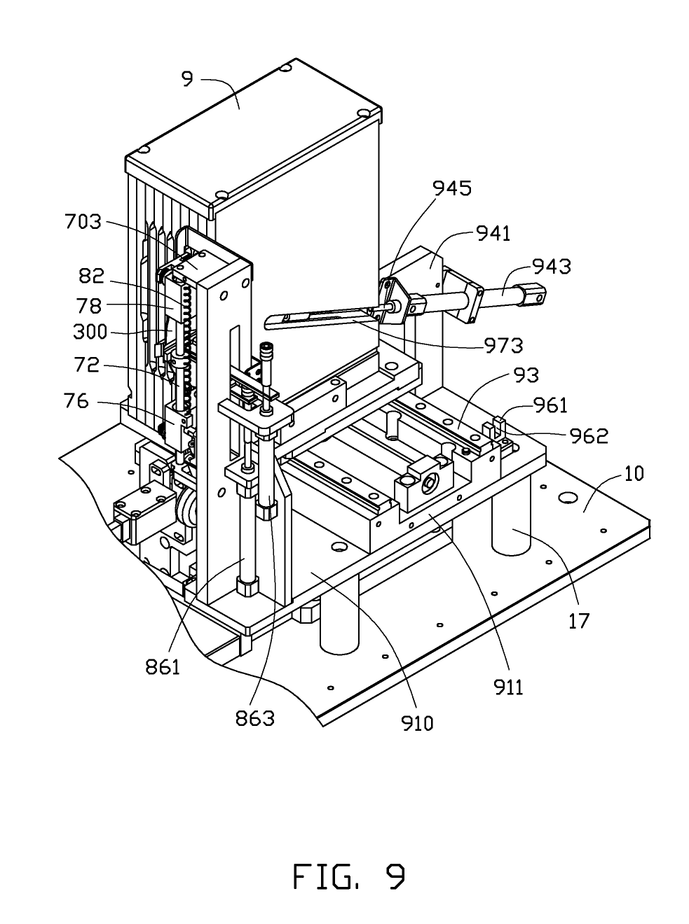

FIG. 10 shows the machine of FIG. 9 viewed from another aspect.

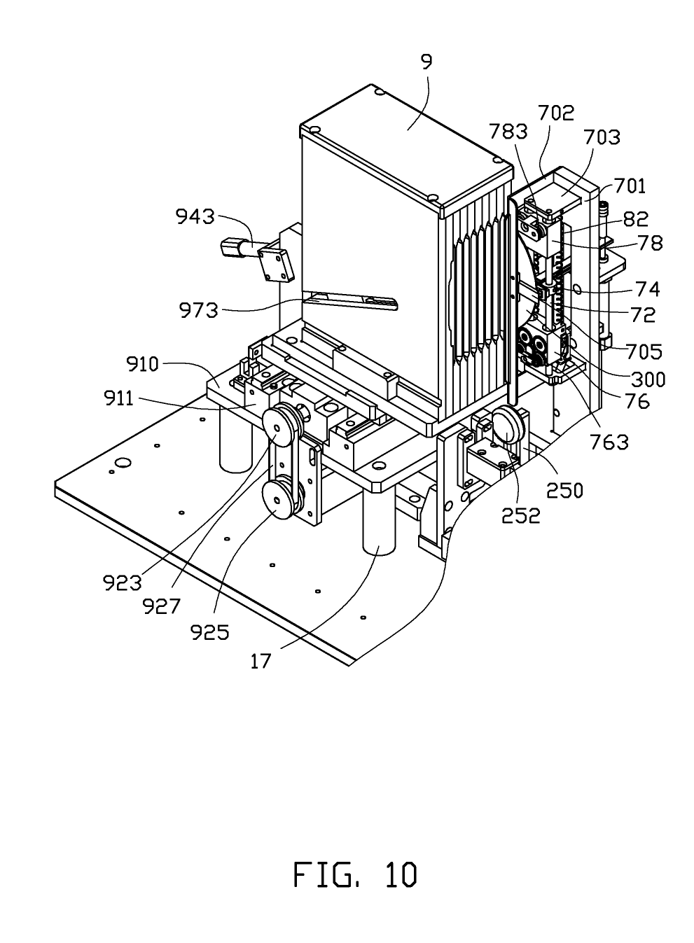

FIG. 11 shows a part of the machine of FIG. 1 being in a second position.

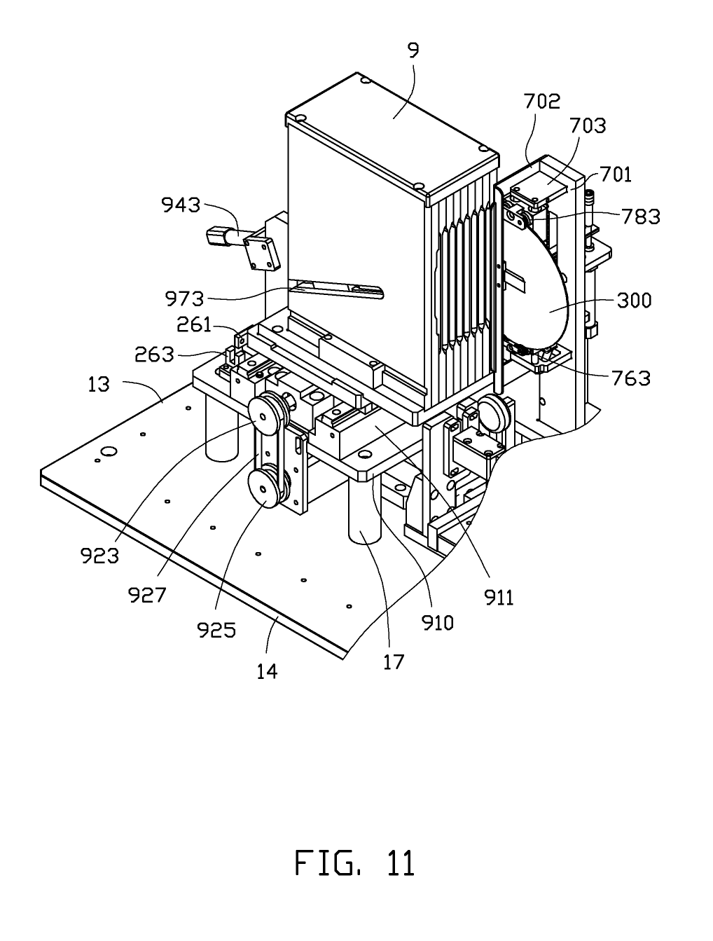

FIG. 12 shows the machine of FIG. 11 viewed from another aspect.

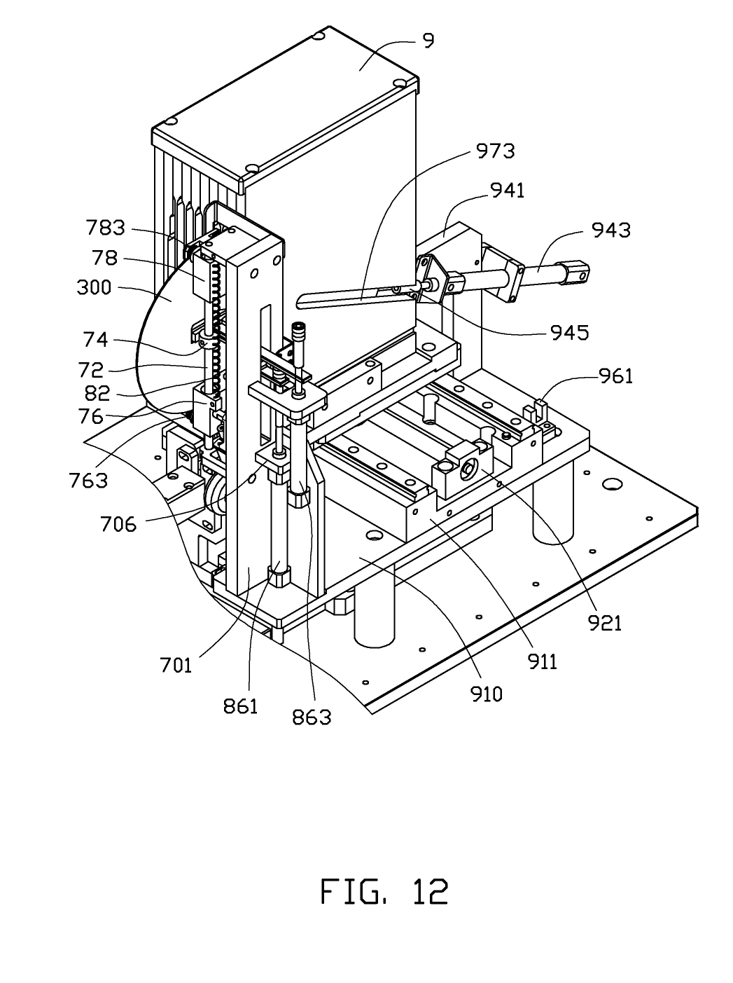

FIG. 13 shows a part of the machine of FIG. 1 being in a third position.

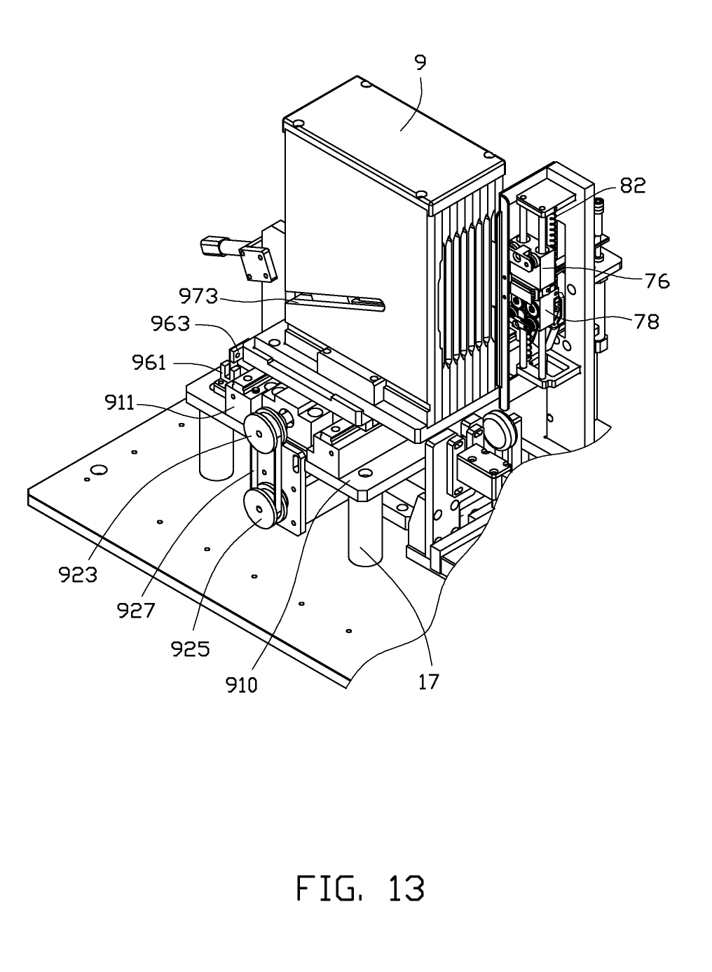

### DETAILED DESCRIPTION

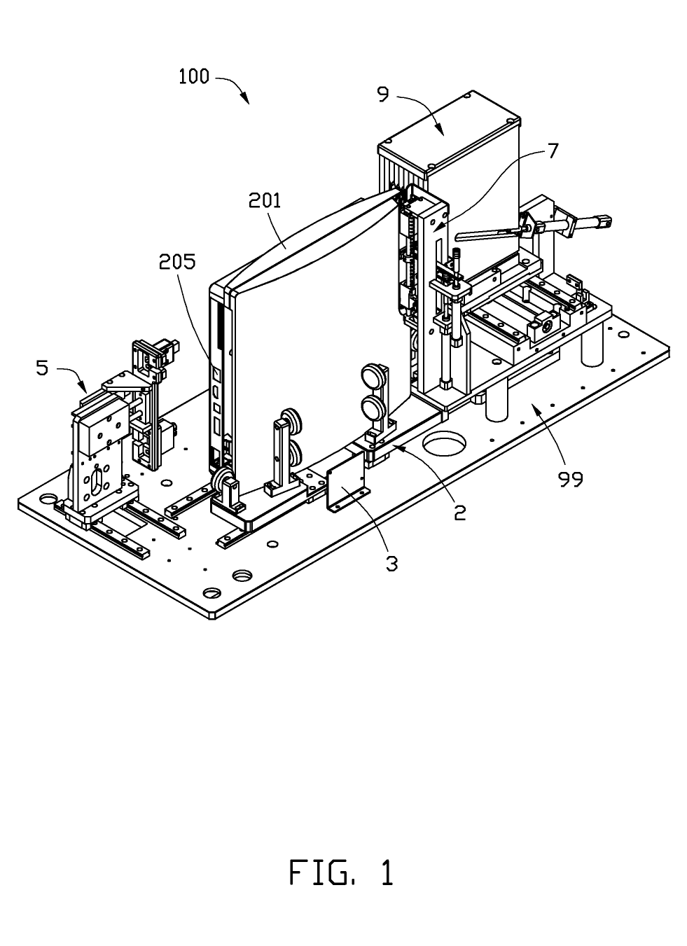

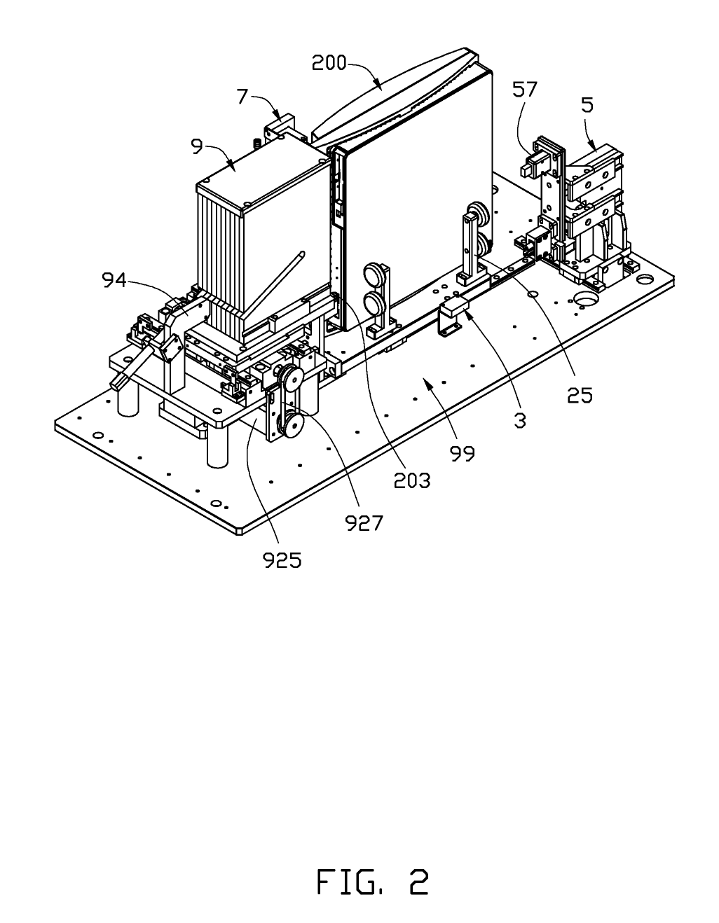

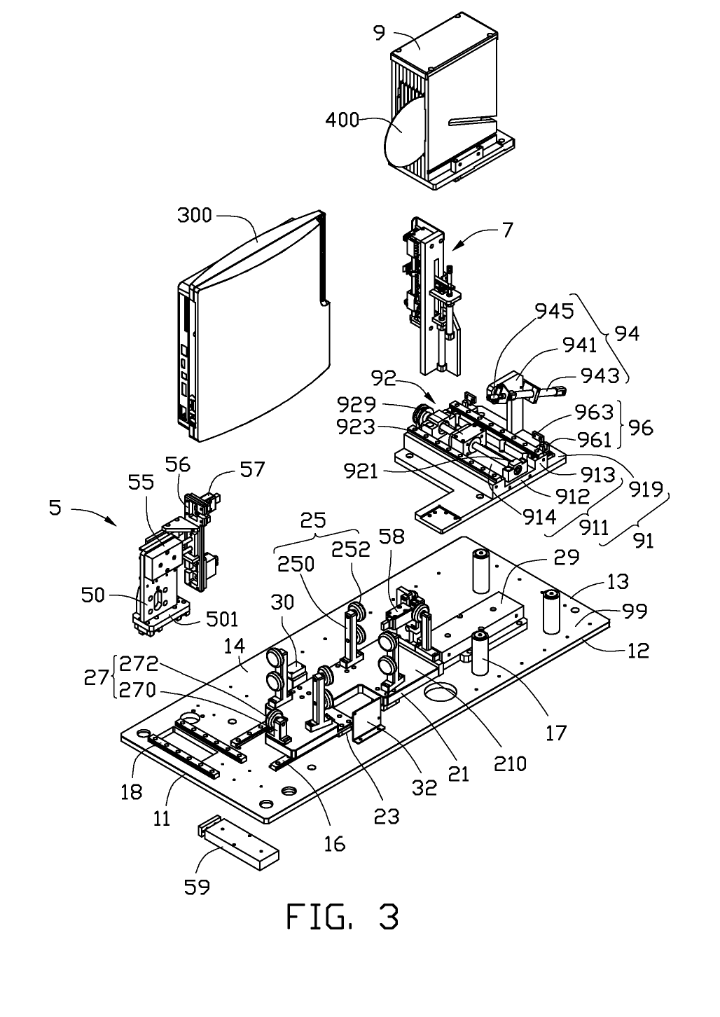

FIGS. 1 and 2 show an embodiment of a machine 100 for automatically loading materials onto a product or unloading the materials from the product. In this embodiment, the product is a slot-in disc device 200. The materials include a number of test discs 400 (see FIG. 3) played by the disc device 200 for testing the disc device 200. The test discs 400 may be in different size or the same size.

The disc device 200 includes a main body 201, a number of first interfaces 203, and a number of second interfaces 205. The main body 201 is substantially rectangular, a side of the main body 201 defines a port (not shown) allowing the test discs 400 to be inserted and ejected from the disc device 200. The first interfaces 203 are positioned in the side of the main body 201, which defines the port. The second interfaces 205 are positioned at a side of the main body 201 opposite to the first interface 203. The first interface 203 and the second interface 205 may be universal serial bus (USB), high definition multimedia interfaces (HDMI), power interface for example.

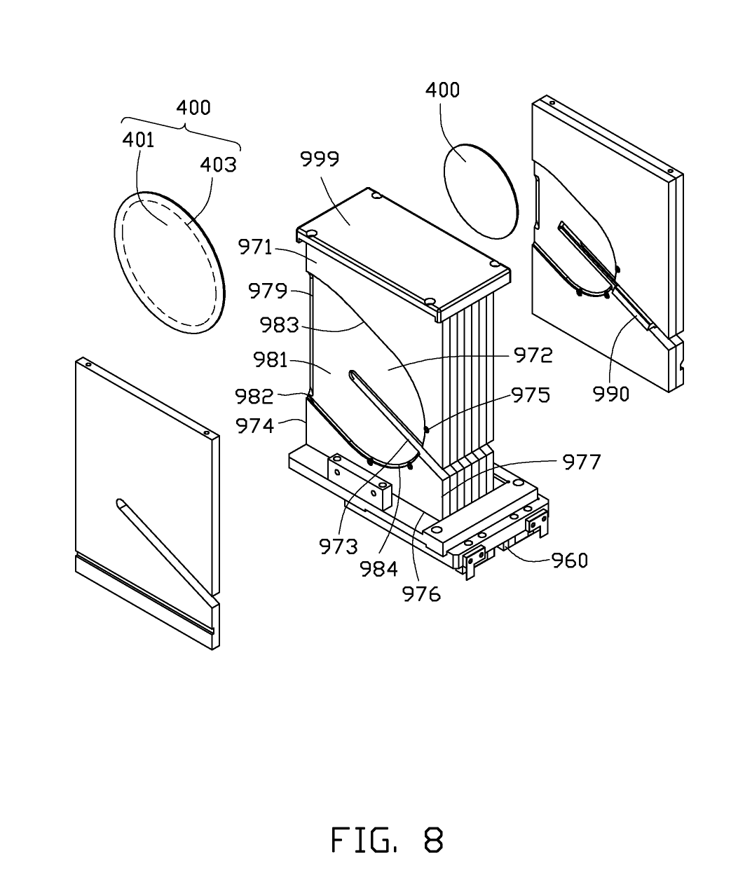

The test disc 400 includes a first region 401 to be protected and a second region 403 not to be protected (see FIG. 8). The first region 401 is used for recording data. The second region 403 is positioned at the outside of the first region 401 and surrounds the first region 401.

The machine 100 includes a platform 1, a positioning device 2, two first sensors 3, a connecting device 5, a transferring device 7, and a containing device 9. The positioning device 2, the first sensor 3, the connecting device 5, the transferring device 7, and the containing device 9 are positioned at intervals on the platform 1. The positioning device 2 is positioned between the connecting device 5 and the transferring device 7 for holding the disc device 200. The first sensors 3 are adjacent to opposite sides of the positioning device 2 for detecting whether the disc device 100 is positioned in the positioning device 2. The connecting device 5 is adjacent to the opposite sides of the main body 201 for coupling to the first and the second interfaces 203, 205. The transferring device 7 is positioned between the positioning device 2 and the containing device 9, and transfers the test discs 400 between disc device 200 positioned in the positioning device 2 and the containing device 9. The containing device 9 receives the test discs 400, and pushes the test discs 400 to the transferring device 7.

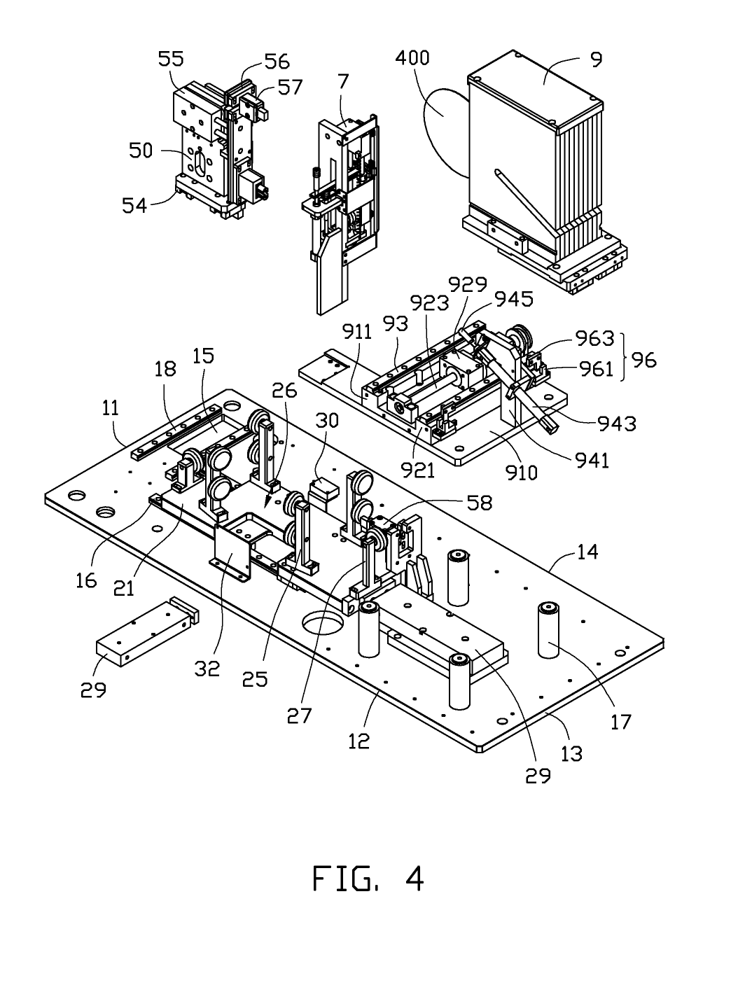

FIGS. 3 and 4 show that the platform 1 is substantially rectangular. The platform 1 includes two first rails 16, four securing posts 17, and two second rails 18. The first rails 16 are positioned at the middle of the platform 1 and parallel to a first edge 12 along the length of the platform 1. The four securing posts 17 are protruding from the platform 1, are columnar and arranged at four vertexes of a rectangle and adjacent to a second edge 13 along the width of the platform 1 which is perpendicular to the first edge 12. The second rails 18 are parallel and adjacent to a third edge 11 which parallel the second edge 13.

The positioning device 2 includes a loading board 21, four sliding blocks 23, four first guiding members 25, two second guiding members 27, and a first driving member 29. The loading board 21 is substantially rectangular. The loading board 21 includes a top surface 210 and bottom surface (not shown). The first sliding blocks 23 are arranged on the bottom surface to engage with the first rails 16 to slidably mount the loading board 21 on the platform 1. The four guiding members 25 are arranged on two lines parallel to the first edge 12, the second guiding members 27 are separately positioned between the two lines and besides the first guiding member 25. A receiving space 26 is defined by the four first guiding members 25 and the two second guiding members 27, and accommodates the disc device 200.

The first guiding member 25 includes a first shaft 250 and two first guiding wheels 252. The first shaft 250 is columnar and perpendicularly protrudes from the top surface 210. The four first shafts 250 are respectively arranged at four corners of a rectangle. The first guiding wheels 252 are fixed on the first shaft 250 separately, and rotate with respect to the first shaft 250. The axis of the guiding wheels 252 is parallel to the platform 1. The second guiding member 27 is similar to the first guiding member 25. The second guiding member 27 includes a second shaft 270 and a guiding wheel 272. The axis of the guiding wheels 272 is parallel to the platform 1 and perpendicular with the axis of the first guiding wheels 252. During the disc device 200 being inserted in the receiving space 26, the first guiding wheels 252 and the second guiding wheels 272 are contacted with the corresponding sides of the disc device 200, and driven to rotate with respect with the disc device 200 to prevent the surface of the disc device 200 from being scratched. The first driving member 29 is positioned besides the loading board 21 to drive the loading boar 21 to move with respect to the platform 1 along the first rails 16. In this embodiment, the first driving member 29 is a cylinder.

The first sensor 3 includes an emitter 30 and a receiver 32. The first emitter 30 and the receiver 32 are adjacent to opposite sides of the first rails 16, and face each other. The emitter 30 emits light to the receiver 32. When the receiver 32 does not receive the light, the receiver 32 determines that the disc device 200 is positioned in the positioning device 2. Otherwise, the receiver 32 determines that the disc device 200 is not positioned in the positioning device 2.

The connecting device 5 includes a connecting board 50, two second sliding blocks 54, a second driving member 55, a fixing board 56, a number of first plugs 57, a second plug 58, and a third driving member 59. The sliding block 54 is mounted on the bottom of the connecting board 50 and engaged with the second rails 18 to slidably mount the connecting board 50 to the platform 1. The second driving member 55 and the fixing board 56 are secured on the connecting board 50, the first plugs 57 are fixed on the fixing board 56. In this embodiment, both cylinders are the second and the third driving members 55 and 59. The second driving member 55 drives the fixing board 56 with the first plugs 57 to move along the first edge 12. The third driving member 59 is positioned beside the second rails 18 to drive the connecting board 50 to move along the third edge 11. Thus the first plugs 57 can be adjusted to be inserted into the first interfaces 205 correspondingly. The second plugs 58 are positioned in an end of the loading board 21 adjacent to the second edge 13. The second plugs 58 are inserted into the first interfaces 203 correspondingly.

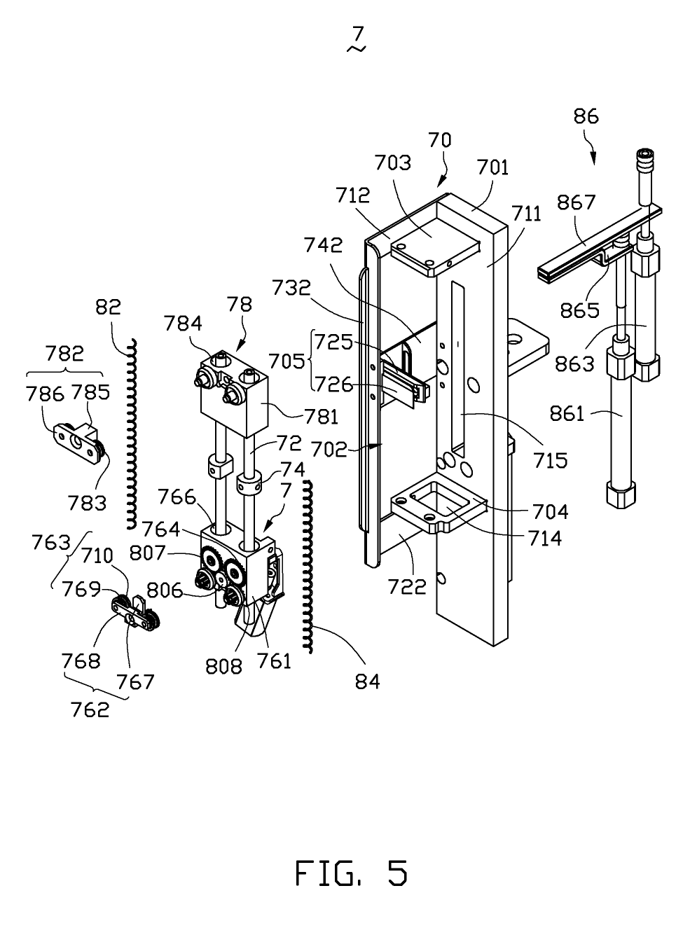

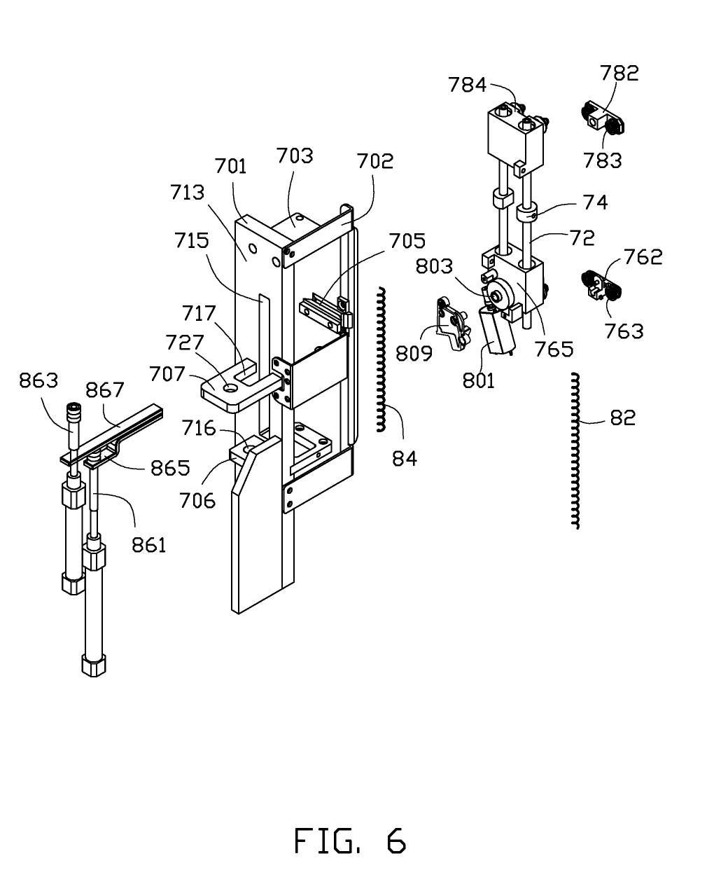

FIGS. 5 and 6 show that the transferring device 7 includes a frame 70, two guiding posts 72, two stopping blocks 74, a first transferring member 76, a second transferring member 78, a driving device 80, a first elastic member 82, a second elastic member 84, and an adjusting member 86.

The frame 70 protrudes from the platform 1. The frame 70 includes a stand 701, a blocking board 702, a first fixing block 703, a second fixing block 704, a limiting member 705, a third fixing block 706, and a fourth block 707. The stand 701 is substantially rectangular.

The stand 701 includes a first surface 711 and a second surface 713 opposite to the first surface 711, and defines a limiting groove 715 through the first surface 711 and the second surface 713. The blocking board 702 includes a securing part 732, a first connecting part 712, a second connecting part 722, and an engaging part 742. The securing part 732 is a strip board. The first connecting part 712 and the second connecting part 722 are perpendicularly extending from the securing part 732 and positioned at opposite ends of the securing part 732, in a same direction. The ends of the first connecting part 712 and the second connecting part 722 away from the securing part 732 are secured to the stand 71, and the securing part 732 faces the first surface 711. The engaging part 742 is positioned between the first connecting part 712 and the second connecting part 722. An end of the engaging part 724 is connected to the stand 71. An opposite end of the securing part 742 horizontally extends towards the securing part 732, and a space (not labeled) is formed between the engaging part 742 and the opposite end of the securing part 732 to allow one test disc 400 to pass through. The first fixing block 703 and the second fixing block 704 protrude from the first surface 711 and are adjacent to opposite ends of the limiting groove 715. The first fixing block 703 is also adjacent to the platform 1. The second fixing block 704 is away from the platform 1. The second fixing block 704 defines an opening 714.

The limiting part 705 includes a first limiting member 725, and a second limiting member 726. The first limiting member 725 is fastened on an end of the engaging part 724 away from the stand 701, the second limiting member 726 is fastened on the securing part 732, and a space is formed between the first limiting member 725 and the second limiting member 726 to allow one test disc 400 to pass through. The third fixing block 706 and the fourth fixing block 707 are separately positioned on the second surface 713. The third fixing block 706 defines a first mounting hole 716. The fourth fixing block 707 defines a gap 717 and a second mounting hole 727. The gap 717 faces the second surface 713. The second mounting hole 727 and the first mounting hole 716 are concentric and arranged at a line parallel to the second surface 713.

The guiding posts 72 are columnar and connected between the first fixing block 703 and the second block 704. The stopping blocks 74 are respectively mounted to the middle of the guiding post 72.

The first transferring member 76 includes a first guiding block 761, a first mounting part 762, and two first carrying wheels 763. The first guiding block 761 is rectangular. The first guiding block 76 defines two first through holes 766. The first guiding block 761 is sleeved on the guiding post 72 from an end of the guiding post 72. The first mounting part 762 is fixed on a side of the guiding block 761, and includes a first base 767 and a first arm 768. An end of the first base 767 is fixed in the middle of the first arm 768. The first carrying wheels 763 are mounted on opposite ends of the first arm 768.

The second transferring member 78 includes a second guiding block 781, a second mounting part 782, and two second carrying wheel 783. The second guiding block 781 is substantially the same with the first guiding block 781. The second guiding block 781 defines two second through holes 784. The second guiding block 781 is sleeved on the guiding post 72 from the other end of the guiding post 72 away from the second guiding block 781 via the second through holes 784. Thus, the second guiding block 781 and the first guiding block 761 are separated by the stopping blocks 74. The second mounting part 782 is fixed on a side of the second guiding block 783, the second guiding block 782 includes a second base 785 and a second arm 786. The second base 785 is fixed in the middle of the second arm 786.

The second carrying wheels 783 are mounted on opposite ends of the second arm 786. In this embodiment, each of the first carrying wheels 763 and the second carrying wheels 783 defines a receiving groove 769 which has a V shaped cross section, and forms two groove walls 770 facing each other. When the test disc 400 is transferred by the transferring device 7, the test disc 400 is held between the first carrying wheels 763 and the second carrying wheels 783. In detail, the first carrying wheels 763 and the second carrying wheels 783 are held at an edge of the test disc 400 in the radial direction. A part of the second regions 403 is received in the test disc 400, the groove walls 770 are contacted with opposite sides of the second region 403, for preventing the first regions 401 from being in contact with other objects. In other embodiments, the transferring device 7 also can transfer other materials besides the test disc 400, and the shapes of the grooves 769 can also be changed to accommodate with the other materials.

The driving device 80 includes a fourth driving member 801, a first pivot 803, a driving wheel 805, a first transferring wheel 806, two second transferring wheels 807, two idle wheels 808, and a cover 809. The fourth driving member 801 is positioned at the first guiding block 761. The first pivot 803 is passed through the first guiding block 761 with two opposite ends extending out of opposite sides of the first guiding block 761 respectively, and the first pivot 803 is parallel to the platform 1. The driving wheel 805 and the first transferring wheel 806 are fixed at the opposite ends of the first pivot 803 respectively, such that the driving wheel 805 and the first transferring wheel 806 are positioned at the opposite sides of the first guiding block 791. The driving wheel 805 and the fourth driving member 801 are positioned at the same side of the first guiding block 761, and the cover 809 is covered on the driving wheel 805 and the fourth driving member 801. The second transferring wheels 807 and the second idle wheels 808 are positioned at the first guiding block 79. Furthermore, the second transferring wheels 807 and the second idle wheels 808 are positioned the same side of first guiding member 761 with the first mounting part 762. The second transferring wheels 807 are engaged with the first transferring wheels 806. The idle wheels 808 are engaged with the second transferring wheels 807, and further coupled to the first carrying wheels 763 via shafts 760. The axis of the driving wheels 805, the first transferring wheels 807, the first carrying wheels 763 and the idle wheels 808 are parallel to each other, thus the driving wheels 805, the first transferring wheels 807, the first carrying wheels 763, and the idle wheels 808 rotate in the same direction. In operation, the fourth driving member 801 enables the driving wheel 805 to drive the first pivot 803 to rotate. The first transferring wheel 806 rotates with the first pivot 803 so as to drive second transferring wheels 807 and the second idle wheels 808 to rotate.

The first elastic member 82 and the second elastic member 84 are springs. The first elastic member 82 is positioned between the first transferring member 76 and the first fixing block 703. The second elastic member 84 is positioned between the second transferring member 78 and the second fixing block 74.

The adjusting assembly 86 includes a fifth driving member 861, a sixth driving member 863, a first supporting member 865, and a second supporting member 867. The fifth driving member 861 is inserted into the first mounting hole 716 and secured to the third fixing block 706. The sixth driving member 863 is inserted into the second mounting hole 727 and secured to the forth fixing block 707. An end of the first supporting member 865 is fixed on a side of the fifth driving member 861 away from platform 1. The other end of the first supporting member 865 is extended between the first transferring member 76 and the second transferring member 78 via the limiting groove 715 and a space between the guiding posts 72. An end of the second supporting member 867 is fixed on a side of the sixth driving member 863 away from platform 1. The other end of the second supporting member 867 is extended into the limiting groove 715. In operation, the fifth driving member 861 drives the first supporting member 865 between opposite ends of the limiting groove 715, the sixth driving member 863 drives the second supporting member 867 between opposite ends of the limiting groove 715. In this embodiment, the fifth driving member 861 and the sixth driving member 863 are cylinders.

FIGS. 3-4 and 7-8 show that the containing device 9 includes a bottom base 91, a driving assembly 92, two guiding rails 93, an ejecting assembly 94, a containing assembly 95, and two second sensors 96.

The bottom base 91 includes a supporting board 910 and a rail seat 911. The supporting board 910 is sleeved on the four securing posts 17 to be secured on the platform 1. The rail seat 911 is fixed on a side of the supporting board 910 away from the platform 1. The rail seat 911 includes two parallel bars 912 protruding from the supporting board 910 and a mounting groove 914 formed by the bars 912 and the supporting board 910.

The driving assembly 92 includes two positioning blocks 921, a thread shaft 923, a motor 925 (see FIG. 2), a belt 927 (see FIG. 2), a mounting block 929. The positioning blocks 921 are adjacent to opposite edges of the supporting board 910 which are adjacent to the first edge 12 and a four edge 14 of the platform 1 opposite to the first edge 12. Opposite ends of the thread shaft 923 are mounted to the positioning blocks 921 and positioned in the mounting groove 914. And the tread shaft 923 is parallel to the second edge 13. The motor 925 is fixed in the platform 1 and connected to the thread shaft 923 via the belt 927 to drive the thread shaft 923 to rotate. The mounting block 929 is sleeved on the thread shaft 923 and move with respect to the supporting board 910 when the thread shaft 923 is rotated. The guiding rails 93 are mounted on the top surface of the bars 913 away from the platform 1, and parallel to the second edge 13.

The ejecting assembly 94 includes a bracket 941, an ejecting member 943 and a rod 945. The bracket 941 is fixed on the supporting board 910 and adjacent to the second edge 13. The ejecting member 943 is mounted on the bracket 941. The ejecting member 943 is inclined to the supporting board 910, an end of the ejecting member 943 is extended toward the rail seat 911 and above the rail seat 911, and an opposite end of the ejecting member 943 is adjacent to the second edge 13. The rod 945 is columnar, and is mounted to the end of the ejecting member 943 above the rail seat 911. The ejecting member 943 drives the rod 945.

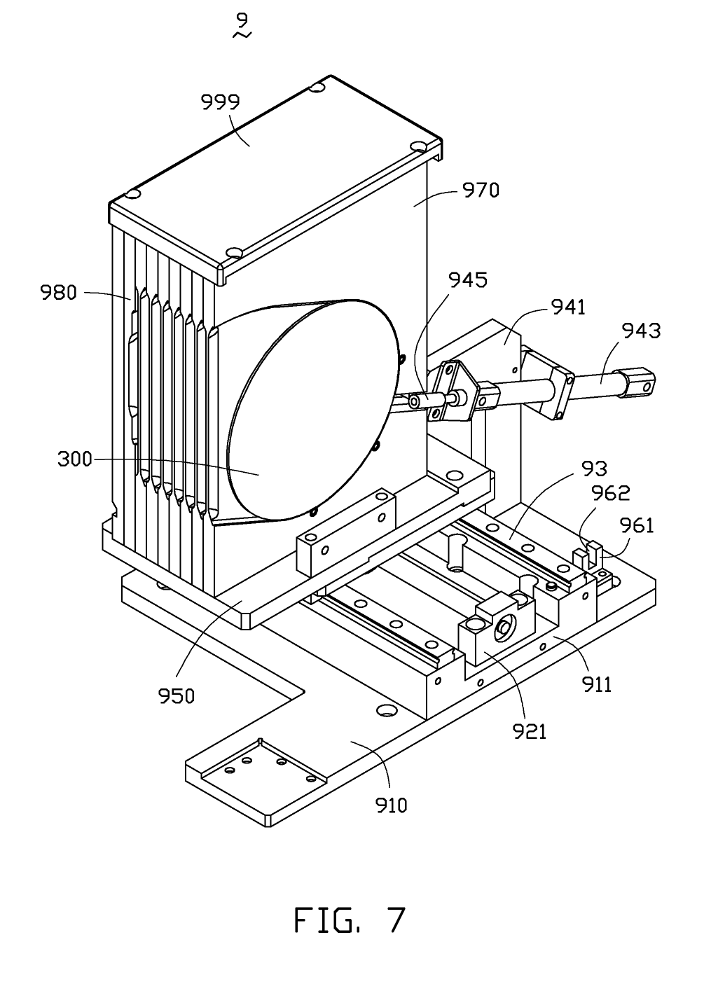

FIGS. 7 and 8 show that the containing assembly 95 includes a base board 950, an engaging block 960, a number of holding members 970 and a cover 999. The base board 950 includes a first loading surface 951 and a second loading surface (not labeled) fixed on the mounting block 929. The engaging block 960 is positioned at the second loading surface and engaging the guiding rails 93 to slidably mount the base board 950 to bottom base 91. Thus, the bottom base 91 slides with the respect to the platform 1 when the mounting block 929 slides. The holding members 970 are arranged on the first loading surface 951 one by one to form a box. In the embodiment, the holding members 970 receive the discs 400 correspondingly.

Each holding member 970 includes a main part 971, a number of cushions 975, a lengthening member 990, and defines a receiving recess 972 and a slot 973. The main part 971 is rectangular. The main part 971 includes a first end 974 adjacent to the transferring device 7, a second end 976 adjacent to the platform 1, a third end 977 opposite to the first end 974, a fourth end (not shown) opposite to the second end 976, and an guiding plane 979.

The receiving recess 972 is defined in a side of the main part 971, by a bottom side 981, a first sidewall 982, a second sidewall 983, and a third side wall 984. The bottom side 981 is depressed from the side of the main part 971 and forms the first sidewall 982, the second sidewall 983, and the third sidewall 984. The first and the second sidewalls 982 and 983 are positioned at opposite edges of the bottom side 981. The first sidewall 982 is adjacent to the second end 977, the second sidewall 983 is adjacent to the forth end. The first and the second sidewalls 982 and 983 are inclined from the fourth end to the second end 976. A distance between ends of the first and the second sidewall 982 and 983 is gradually reduced from the first end 973 to the third end 977. The distance between ends of the first and the second sidewall 982 and 983 third sidewall 984 adjacent to the first end 973 is larger than the test disc 400. The third sidewall 984 protrudes from an edge of the bottom side 982, the third sidewall 984 is connected between the first and the second sidewalls 982 and 983 and adjacent to the third end 978. In this embodiment, the first and the second sidewalls 982 and 983 are straightly extended from the first end 973 to the third end 977. The third sidewall 984 is cambered. An inlet 985 is formed between ends of the first and the second sidewalls 982, 983 and adjacent to the first end 973, such that the test disc 400 is passed into the receiving recess 972 via the inlet 985. The guiding plane 979 is formed on the first end 973, and is inclined upward from the bottom side 981 to the inlet 985 to guide the test disc 400 to enter into the receiving recess 972.

The slot 973 is defined in the main body 981 and is straightly extended from the third end 978 to the middle of the bottom side 981. The ejecting member 943 drives the rod 945 into the slot 973. The cushions 975 are separately positioned at the first and the third sidewalls 982, 984 to prevent the test disc 400 from bumping into main body 981 when the test disc 400 is slid into the receiving recess 972.

The lengthening member 990 is positioned at the slot 973 which is driven by the rod 945 to push the test disc 400 out of the holding member 970. The lengthening member 990 is made of rubber. The cover 999 is covering the holding members 970 and away from the base board 950 for combining the holding members 970 together. When assembling, all the holding members 970 are arranged one by one in the same orientation.

Each second sensor 96 includes a sensing part 961 and a reflection sheet 963 corresponding to the sensing part 961. The sensing parts 961 are separately positioned at opposite ends of the supporting board 910. The sensing part 961 defines a receiving channel 962. The reflection sheets 963 are separately positioned at opposite ends of the base board 950. In this embodiment, the second sensors 96 are raster sensors. The second sensors 96 are configured to determine whether the containing assembly 95 has been moved a largest distance to determine whether the disc device 200 has read all the test discs 400.

In an original state of the machine 100 for loading and unloading materials, the test discs 400 are received in the holding member 970 correspondingly. The first transferring member 76 and the second transferring member 78 restricts against opposite ends of the stopping blocks 74. The reflection sheet 963 adjacent to the fourth edge 14 is received in the receiving channel 962 adjacent to the fourth edge 14 and there is a distance between the other reflection sheet 963 and the other receiving channel 962. The first holding member 970 adjacent to the first edge 12 faces to the space forming between the first transferring member 76 and the second transferring member 78.

In operation, first, the disc device 200 is loaded on the loading board 21. In detail, the disc device 200 is placed above the first and the second guiding members 25 and 27, then the disc device 200 is moved down to the loading board 21 guided by the first and the second guiding members 25 and 27. The first sensor 3 generates a first signal when the first sensor 3 detects that the disc device 200 is loaded on the loading board 21.

Second, the disc device 200 is started up. In detail, the first driving member 29 responses to the first signal to drive the loading board 21 to move away from the third edge 11 along the second rails 16, so as to insert the second plug 58 into the first interface 203. The third driving member 59 responses to the first signal to drive the connecting device 5 to move along the second guiding rails 18 toward the first edge 12, to enable the first plug 57 to face the second interface 205. The first plug 57 is further driven by the second driving member 55 to the loading board 21 to insert the first plug 57 into the second interface 205 for starting up the disc device 200.

Third, the first transferring member 76 and the second transferring member 78 are driven away from each other to receive the test disc 400, and the first elastic member 82 and the second elastic member 84 are dragged to generate elastic forces. In detail, the fifth driving member 861 drives the first supporting member 865 to move toward the platform 1, at the same time, the supporting member 865 drives the first transferring member 76 to move toward the platform 1. The sixth driving member 863 drives the second supporting member 867 to move away the platform 1, at the same time, the supporting member 865 drives the second transferring member 78 to move away from the platform 1.

Fourth, the test disc 400 received in the first holding member 970 is driven to position between the first transferring member 76 and the second transferring member 78. In detail, the ejecting member 943 drives the rod 945 to move into the holding member 970 via the slot 973. In addition, a part of the test disc 400 is pushed by the rod 945 to move out of the holding member 970, and is positioned between the first transferring member 76 and the second transferring member 78 through the space between the engaging part 742 and the securing part 732.

Fifth, the first carrying wheels 763 and the second carrying wheels 765 are driven to grip the edge of the test disc 400 from opposite sides of the test disc 400. In detail, the fifth driving member 861 and the sixth driving member 863 are driven to move the first supporting member 865 and the second number 867 toward each other. Thus, the first elastic member 82 and the second elastic member 84 release the elastic force to drive the first transferring member 76 and the second transferring member 78 to move toward each other. As a result, the first carrying wheels 763 and the second carrying wheels 783 move toward each other, and the test disc 400 is clamped between the first carrying wheels 763 and the second carrying wheels 783.

Seventh, the first carrying wheels 763 and the second carrying wheels 783 are rotated, such that the test disc 400 is transferred to the disc device 200. In detail, when the test disc 400 is transferred, the first engaging block 725 and the second engaging block 726 restrict against opposite sides of the test disc 400, the groove walls 770 protect the first part 401 to prevent the test disc 400 being scratched.

Eighth, the test disc 400 is drawn into the disc device 200 when the test disc 400 comes closer the port of the disc device 200. At this time, the first transferring member 76 and the second transferring member 78 abut against the opposite sides of the stop block 74.

Ninth, when disc device 200 has been tested the test disc 400, the first transferring member 76, and the second transferring member 78 are driven away from each other to receive the test disc 400.

Tenth, the test disc 400 is ejected from the port of the disc device 200 to position between the first transferring member 76 and the second transferring member 78.

Eleventh, the first carrying wheels 763 and the second carrying wheels 765 are driven to grip the edge of the test disc 400 from opposite sides of the test disc 400, which is described in the “Fifth” step.

Twelfth, the test disc 400 is transferred to the containing device 9, which is similar to “Sixth” step.

Thirteenth, when the test disc 400 is transferred to the containing device 9, and the test disc 400 is positioned at the guiding plane 979, the first carrying wheels 763 and the second carrying wheels 765 are driven to release the test disc 400 by the fifth driving member 861 and sixth driving member 865. As a result, the test disc 400 slides into the receiving recess 972 because of the force due to gravity of the test disc 400. Next, the containing assembly 95 is driven by the driving assembly 92 to move a predetermined distance to the first edge 12 enabling the next holding member 970 to face the space between the first transferring member 76 and the second transferring member 78.

Repeating the above the “Third” to “Twelfth” steps, when the test disc 400 which is received from the disc device 200 and the reflection sheet 963 adjacent to the first edge 11 is received in the receiving channel 962 adjacent to the first edge 11, the disc device 200 has completely read all the test disc 400.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A transferring device for transferring materials, the materials comprising a first region to be protected, and a second region not to be protected, the transferring device comprising:
a frame;
a first transferring member mounted on the frame;
a second transferring member mounted on the frame and separated from the first transferring member, and a driving device;
wherein one of the materials is clamped between the first transferring member and the second transferring member; the first transferring member and the second transferring member are separated from the first region, and are driven by the driving device to force the one material to transfer from a first position to a second position.

2. The transferring device of claim 1, wherein the first transferring member comprises a first carrying wheel, the second transferring member comprises a second carrying wheel, the material is clamped between the first carrying wheel and the second carrying wheel, the first carrying wheel and the second carrying wheel are driven to rotate by the driving device, so as to force the material to transfer from the first position to a second position between the first carrying wheel and the second carrying wheel.

3. The transferring device of claim 2, wherein each of the first carrying wheel and the second carrying wheel defines a receiving groove, and two groove walls facing each other, when the material is clamped between the first carrying wheel and the second carrying wheel, the second part are located in the receiving groove, the first part are located between the groove walls and separated from the groove walls.

4. The transferring device of claim 1, wherein the transferring device further comprising an adjusting member, the adjusting assembly drives the first transferring member and the second transferring member to move away from each other to enable the first carrying wheel and the second carrying wheel to move away from each other.

5. The transferring device of claim 4, wherein the transferring device further comprising a first elastic member, and a second elastic member, the first elastic member is located between the first transferring member and the frame, the second elastic member is located between the second transferring member and the frame, when the adjusting member drives the first transferring member and the second transferring member to move away from each other, the first elastic member and the second elastic member are deformed to generate first elastic forces for driving the first transferring member and the second transferring member to move toward each other.

6. The transferring device of claim 5, wherein when the material is received in the first transferring member and the second transferring member, the first elastic member and the second elastic member are forced to generate second elastic forces which is smaller than the first elastic force for driving the first transferring member and the second transferring member to move toward each other.

7. The transferring device of claim 4, wherein the adjusting member comprises a driving member, a first supporting member, and a second supporting member, the driving member drives the first supporting member to drive the first transferring member to move away from the second transferring member, the driving member drives the second supporting member to drive the second transferring member to move away from the first transferring member.

8. The transferring device of claim 5, wherein the first supporting member and the second supporting member are located between the first transferring member and the second transferring member, the first supporting member is adjacent to the first transferring member, the second supporting member is adjacent to the second transferring member.

9. The transferring device of claim 4, further comprising two guiding post and a stopping block, the stopping block is fixed on the guiding post, the first transferring member and the second transferring member are slidably sleeved on the guiding post, the stopping block is located between the first transferring member and the second transferring member.

10. The transferring device of claim 1, wherein the transferring device transfers the materials of discs, the first region of the discs is recorded data and surrounded by the second region.
